(19) United States
(12) Patent Application Publication
(10) Pub. No.: US 2014/0263781 A1
(43) Pub. Date: Sep. 18, 2014

(54) BONE MILL ASSEMBLY FOR USE WITH CORTICAL AND CANCELLOUS BONE

(71) Applicant: Rafferty Holdings, LLC dba Rafferty Machine and Tool, (US)

(72) Inventors: Conway TOMLINSON, Greencove Springs, FL (US); James ROBINSON, Gainesville, FL (US)

(73) Assignee: Rafferty Holdings, LLC dba Rafferty Machine and Tool, Gainesville, FL (US)

(21) Appl. No.: 13/835,329

(22) Filed: Mar. 15, 2013

(51) Int. Cl. B02C 23/16

(52) U.S. Cl. CPC B02C 23/16
USPC 241/69

(57) ABSTRACT

A bone mill assembly provides a drive motor with a reducer. The drive motor is connected to a non-rotating coupler which is connected to a main drive cutting head. A mill housing consists of a manual feed chute or a pneumatic feed chute that shuttles the bone stock onto the main drive cutting head of the mill. The bone stock is ground to a smaller particle size and then shuttled by rotation onto a straight secondary blade. This chops the particle size even smaller and then is sized by an internal window sieve. If the particle size is small enough, the bone particulate passes through the sieve into a collection pan. If the particle size is too large, it will then be rotated back up within the housing to be processed again by the main cutting head. Different sizes of the main cutting head are used for customer specific applications.

### FIELD OF THE INVENTION

The present invention generally relates to medical devices and their use. More particularly, the present invention relates to a bone mill assembly for use in a surgical, medical, or other environment where ground cortical and cancellous bone particles are needed.

### BACKGROUND OF THE INVENTION

Ground bone particles can be used in various medical, surgical and dental procedures. Finely ground bone particles can be used for spinal fusions, to repair defects caused by trauma, transplant surgery, or tissue banking.

In the prior art, it is well known that a surgeon, for example, may remove a portion of bone from a patient, grind the portion into fairly homogenous particles using a hand-powered rasp, and then use the bone particles to patch and repair another area of bone, such as on the patient's spinal cord or skull.

The grinding of bone using a hand-powered rasp is a relatively long and strenuous process, however, and one that tends to yield mixed results depending on the bone, the rasp, and the operator's ability. Further, as with all medical and surgical instrumentation, the hand-powered rasp must be sterile, and must be maintained in an absolutely sterile condition during the surgical procedure to avoid contact with any toxic debris and other contaminants. Instruments such as the hand-powered rasp are typically disassembled, sterilized using an autoclave or other sterilization procedure, and then reassembled. However, it is generally recognized that the use of rasps for bone milling is an inherently wasteful and time consuming process. Further, it is difficult to mix various additives to the bone particles, such as an additive that promotes bone growth, during the rasping process.

Other more mechanized bone milling methods have been used in attempts to produce specific sized bone particles. Such methods have included using coffee grinders and wood chippers to repeatedly grind bone fragments from large to smaller particle sizes. These methods also take a relatively long time to bone grind because of the number of cycle passes that are required to obtain smaller particle sizes. Further, such equipment is not designed with the clean room environment in mind and they cannot be autoclaved, which significantly increases the unacceptable risk of cross contamination throughout the grinding process.

Still other methods have attempted to use electromechanical bone milling devices having primary and secondary interlocking rotary cutting heads. In the experience of these inventors, such devices are bulky and do not lend themselves to functioning as a true laboratory or portable bone mill. Further, other methods and devices tend to utilize larger and faster motors which tend to overheat the bone and particulate. Such overheating, in the view of these inventors, essentially renders the harvested bone particulate useless.

In the view of the foregoing prior art, these inventors believe that there is a need to provide an improved bone mill assembly that is portable, can be easily autoclaved and is compartmentalized to provide easy access for purposes of cleaning and sterilizing of the component parts. There is also a need to provide such a bone mill that would comprise a structure to solve the problem of multi-cycle grinding whereby processed bone yield is maximized and homogeneous particulate sizes of bone are produced, all of which is accomplished without overheating the product.

Such a bone mill would be modular and easily and quickly assembled and disassembled as needed. Such a bone mill would also have the built-in capacity to variably grind large pieces of cortical bone and cancellous bone to customer specific sizes, those ranges being from 125 microns to 850 microns for cortical bone and 1 millimeter through 4 millimeters for cancellous bone. Lastly, there is a need to provide such a bone mill that requires the bone fragments and particulate to be handled only one time during the grinding process which further decreases the chances for cross-contamination of the bone particulate.

### SUMMARY OF THE INVENTION

Accordingly, a primary object of the present invention is to provide a new, useful and non-obvious bone mill assembly that can be easily autoclaved and compartmentalized to provide easy access for purposes of cleaning and sterilizing of the component parts; that provides a solution to the problem of multi-cycle grinding whereby processed bone yield is maximized and homogeneous particulate sizes of bone are produced; that prevents the bone and particulate from overheating; and that needs to be handled only once during the grinding process which decreases the chances for cross-contamination of the bone particulate.

The bone mill assembly of the present invention obtains these objects. It provides a drive motor with a reducer which reduces the revolutions per minute (RPM) while increasing torque to the optimum condition that is required to grind bone fragments or stock effectively and without overheating. Overheating of the bone fragments and particulate occurs with larger and faster motors, which essentially renders the ground product useless for its intended purpose. The drive motor in the assembly of the present invention grinds the product efficiently and without burning. The drive motor is connected to a non-rotating coupler and the coupler is, in turn, connected to the main drive grinding or cutting head of the mill. The assembly further includes a mill housing which consists of a manual feed chute or a pneumatic feed chute that shuttles the bone stock onto the main drive grinding or cutting head of the mill. The bone stock is ground to a smaller particle size and then shuttled by rotation onto a straight secondary blade. This chops the particle size even smaller and then is sized by an internal window sieve. If the particle size is small enough, the bone passes through the sieve into a collection pan. If the particle size is too large, it will then be rotated back up within the housing to be processed again by the main grinding or cutting head. Different sizes of the main grinding or cutting head are used for customer specific applications. The internal sieve design is unique and is the only one of its kind that also allows grounds lipids and fat to be washed out of the assembly during cleaning.

The foregoing and other features of the apparatus of the present invention will be apparent from the detailed description that follows.

### BRIEF DESCRIPTION OF THE DRAWINGS

FIG. 1 is a top, front and right side perspective view of a bone mill assembly that is constructed in accordance with the present invention and showing the bone mill assembly as it would used, for example, on a sterile back table in a surgery suite.

FIG. 2 is an exploded view of the bone mill assembly shown in FIG. 1.

FIG. 3 is an enlarged and exploded reverse perspective view of the mill housing of the bone mill assembly shown in FIGS. 1 and 2.

FIG. 4 is a cross-sectioned view of the mill housing taken along line 4-4 of FIG. 2.

FIG. 5 is an enlarged and exploded view of the feed chute of the bone mill assembly shown in FIGS. 1 and 2.

### DETAILED DESCRIPTION

Referring now to the drawings in detail, wherein like numbered elements refer to like elements throughout, FIG. 1 illustrates the bone mill assembly, generally identified 10, which is constructed in accordance with the present invention. The bone mill assembly 10 is configured to include a working surface 2, the surface 2 being supported by a plurality of legs 4. The significance of the elevated working surface 2 is that milled bone particulate (not shown) can be collected in some sort of collection pan or container (also not shown) that can be secured beneath the surface 2. Accordingly, it is to be understood that the illustrated embodiment is not a limitation of the present invention and that the working surface 2 and legs 4 could assume most any configuration for purposes of the present invention. It is, however, preferable that the surface 2 and legs 4 be constructed of stainless steel for purposes of post-use sterilization.

A drive motor and reducer, generally and generically identified 6, is provided as part of the assembly 10 and is connected to a drive axle, generally and generically identified 8. The drive motor and reducer 6 reduce the RPM of the motor while increasing torque to the optimum condition required for grinding bone stock effectively and without overheating the stock and resulting particulate. The coupler and drive axle 8 is connected to a bone mill housing, generally identified 40.

Referring now to FIG. 2, it illustrates the bone mill assembly 10 in an exploded format, which more clearly shows a mill housing base 20, the mill housing 40 and a feed tower 80. The mill housing base 20 comprises a flat rectangular structure that is attachable to the working surface 2 using suitable fasteners (not shown). The mill housing base 20 has an aperture 22 defined in it and the working surface 2 has a similarly sized aperture 12 defined in it. These apertures 12, 22 are aligned to provide a conduit through which bone particulate can drop and accumulate during the milling process. It is preferable that the mill housing 40 and the feed tower 80 constructed of stainless steel for purposes of post-use sterilization.

The bone mill housing 40 is illustrated in an exploded view in FIG. 3. The housing 40 comprises a main bone mill housing block 41. The block 41 has a central open area that is accessible via a combined bottom and side aperture 42, a bottom aperture 44, opposing round end apertures 46 and a top aperture 48. The combined bottom and side aperture 42 is configured to receive a sieve or screen holder 72 and sieve or screen 74 in it. See FIG. 4. The combined bottom and side aperture 42 is a bone particulate “outlet,” which outlet is located such that it is disposed above the aperture 22 of the mill housing base 20 and the aperture 12 of the working surface 2. Again, these apertures 12, 22, 42 are aligned to provide a conduit through which bone particulate can drop and accumulate during the milling process.

In the preferred embodiment, multiple such screens 74 are provided. Each screen 74 has uniform sized openings defined in it which allows the user to very precisely control the size of bone particulate that passes through the screen holder 72 and screen 74, the screen 74 including a mesh of a given opening size. In particular, screen mesh openings sized 300 microns to 850 microns, 1 to 2 millimeters and 1 to 4 millimeters are preferred. Alternatively, a spacer (not shown) could be used in place of the screen 74 and holder 72 for large particle sizes and cancellous bone in particular. It is preferable that the screen holder 72 and screen 74 be constructed of stainless steel for purposes of post-use sterilization.

The bottom aperture 44 of the main bone mill housing block 41 is configured to receive a secondary cutting blade 54 in it. This secondary cutting blade 54 is stationary. It should be noted that the secondary cutting blade 54 may be provided as a serrated secondary blade which is intended for use only with cortical bone for producing finer particle sizes. The secondary cutting blade 54 may also be provided as a blank secondary blade which is intended for cutting larger particle size of cortical bone and for cancellous bone particulate. It is preferable that the secondary cutting blade 54 be of stainless steel construction for purposes of post-use sterilization.

The screen holder 72 and the secondary cutting blade 54 are held in position by a base plate 62 that is attachable to the bottom of the main bone mill housing block 41 using suitable fasteners (not shown). An outboard, or solid, end cap 64 is provided which is attachable to that end of the main bone mill housing block 41 furthest away from the drive motor and reducer 6. The inner surface of the end cap 64 is used to seat a main grinding or cutting head assembly 52 when the assembly 52 in inserted substantially horizontally into the main bone mill housing block 41. This is done by inserting the main cutting head assembly 52 through the end aperture 46 that is opposite the end cap 64. A shaft end cap 66 is then provided which supports the main cutting head assembly 52 at that end of the main bone mill housing block 41 nearest the drive motor and reducer 6. It is preferable that the end cap 64, main cutting head assembly 52 and shaft end cap 66 be constructed of stainless steel for purposes of post-use sterilization.

It should also be mentioned here that the main grinding or cutting head assembly 52 is a substantially drum-shaped structure that is preferably configured in one of three different types. A first type of cutting head is in an assembly 52 for milling cancellous bone. A second type is an assembly 52 for milling cortical bone. A third type is an assembly 52 for milling dental powder. Each type of cutting head assembly 52 is contemplated within the scope of the present invention.

The top aperture 48 of the main bone mill housing block 41 is configured to receive a primary cutting blade 56 in it. A top plate 68 is then provided to seal off the main bone mill housing block 41 with the main grinding or cutting head assembly 52 rotatably sealed within it. See also FIG. 3, which is a cross-section of the housing assembly 20 when it is fully assembled. It is to be noted that the rotation of the main cutting head assembly 52 within the main bone mill housing block 41 is counterclockwise in reference to FIG. 3 as shown. It is preferable that the primary cutting blade 56 and top plate 68 be constructed of stainless steel for purposes of post-use sterilization.

The top plate 68 comprises an aperture 69 and a pair of extension members 67 for securing the feeder tube, or tower, 80 to the housing 20. The aperture 69 serves as an “inlet” for bone stock to enter the housing block 41. The tower 80 comprises a shaft 82 that allows an impeller member 84 to push bone fragments or stock (not shown) while the main cutting head assembly 52 is rotating within the housing 20. A top seal 86 is provided as is a rod 88 that is used to push the impeller member 84 downwardly into the housing 20 during operation. The assembly 10 of the present invention can be configured to allow for manual or pneumatic actuation of the impeller member 84. It should also be noted that a fluid wash line may be attached to the housing 20 to allow for water to be circulated within the housing 20 during the milling process, if necessary.

In application, the bone mill assembly 10 provides a drive motor with a reducer 6 which reduces the revolutions per minute (RPM) while increasing torque to the optimum condition that is required to grind bone fragments or stock effectively and without overheating. Overheating of the bone fragments and particulate occurs with larger and faster motors, which essentially renders the ground product useless for its intended purpose. The drive motor 6 in the assembly 10 of the present invention grinds the product efficiently and without burning. The drive motor 6 is connected to a non-rotating coupler 8 and the coupler 8 is, in turn, connected to the main drive grinding or cutting head assembly 52 of the mill 40. The assembly 10 further includes a mill housing 40 which consists of a manual feed chute or a pneumatic feed chute 80 that shuttles the bone stock onto the main drive grinding head assembly 52 of the mill 40. The bone stock is ground to a smaller particle size and then shuttled by rotation onto a straight secondary cutting blade 54. This chops the particle size even smaller and then is sized by the internal window sieve or screen 74. If the particle size is small enough, the bone passes through the sieve or screen 74 into a collection pan (not shown). If the particle size is too large, it will then be rotated back up within the housing block 41 to be processed again by the main grinding head assembly 52. Different head sizes for the main cutting head assembly 52 are used for different customer applications. The internal sieve design is unique and is the only one of its kind that also allows grounds lipids and fat to be washed out of the assembly during cleaning.

Based upon the foregoing, it will be apparent that there has been provided a new, useful and non-obvious bone milling assembly that can be easily autoclaved and compartmentalized to provide easy access for purposes of cleaning and sterilizing of the component parts; that provides a solution to the problem of multi-cycle grinding whereby processed bone yield is maximized and homogeneous particulate sizes of bone are produced; that prevents the bone and particulate from overheating; and that needs to be handled only once during the grinding process which decreases the chances for cross-contamination of the bone particulate.

The principles of this invention having been fully explained in connection with the foregoing, we hereby claim as our invention:

1. A bone mill assembly for use with cortical and cancellous bone comprising:
a working surface, said surface being supported by a plurality of legs;
a drive motor and reducer mounted to said surface;
a drive axle attached to the drive motor and reducer;
a mill housing comprising a bone stock inlet and a bone particulate outlet;
a main cutting head assembly rotatably disposed within the mill housing;
a primary cutting blade;
a secondary cutting blade; and
a sieve disposed at the bone stock outlet of the mill housing;
wherein bone stock entering the inlet is milled into bone particulate, which particulate drops through the sieve in accordance with a desired particulate size.

2. The bone mill assembly of claim 1 wherein the mill housing, main cutting head assembly, primary and secondary cutting blades and sieve are constructed of stainless steel.

3. The bone mill assembly of claim 1 further comprising a holder for removably receiving the sieve therewithin.

4. The bone mill assembly of claim 3 wherein the sieve holder is removably attached to the mill housing.

5. The bone mill assembly of claim 4 wherein the sieve mesh is variably configured to pass milled bone particulate of various sizes.

6. The bone mill assembly of claim 4 wherein the sieve holder is constructed of stainless steel.

7. The bone mill assembly of claim 1 further comprising a tower, said tower being mounted at the bone stock inlet of the mill housing.

8. The bone mill assembly of claim 7 wherein said tower comprises means for impelling bone stock toward the main cutting head assembly of the mill housing.

9. The bone mill assembly of claim 8 wherein the tower further comprises means for variably impelling bone stock via mechanical means and via pneumatic means.

10. The bone mill assembly of claim 9 wherein the tower is constructed of stainless steel.

11. A bone mill assembly for use with cortical and cancellous bone comprising:
a working surface, said surface being supported by a plurality of legs;
a drive motor and reducer mounted to said surface;
a drive axle attached to the drive motor and reducer;
a mill housing block comprising a top-disposed bone stock inlet and a bottom-disposed bone particulate outlet;
a drum-shaped main cutting head assembly rotatably disposed within the mill housing block, said main cutting head assembly being variably configured to mill cortical bone, cancellous bone and dental powder;
a solid end cap for supporting a portion of the main cutting head assembly within the mill housing block;
a shaft end cap for supporting a portion of the main cutting head assembly within the mill housing block;
a primary cutting blade disposed within the top of the mill housing block;
a secondary cutting blade disposed within the bottom of the mill housing block;
a sieve holder that is removably disposed within the bottom of the mill housing block and having an arcuate contour that substantially matches that of the head of the drum-shaped main cutting head assembly; and
a sieve having a sieve mesh disposed within the sieve holder at the bone stock outlet of the mill housing;
wherein bone stock entering the inlet is milled into bone particulate, which particulate drops through the sieve mesh in accordance with a desired particulate size.

12. The bone mill assembly of claim 11 wherein the mill housing, the main cutting head assembly, the end caps, the primary and secondary cutting blades, the sieve holder and the sieve are each constructed of stainless steel.

13. The bone mill assembly of claim 11 wherein the sieve mesh is variably configured to pass milled bone particulate of various sizes.

14. The bone mill assembly of claim 11 further comprising a tower, said tower being mounted at the bone stock inlet of the mill housing.

15. The bone mill assembly of claim 14 wherein said tower comprises means for impelling bone stock toward the main cutting head assembly of the mill housing.

16. The bone mill assembly of claim 15 wherein the tower further comprises means for variably impelling bone stock via mechanical means and via pneumatic means.

17. The bone mill assembly of claim 16 wherein the tower is constructed of stainless steel.
